(19) United States
(12) Patent Application Publication
(10) Pub. No.: US 2017/0191839 A1
(43) Pub. Date: Jul. 6, 2017

(54) USING ACTIVITY PROFILES

(71) Applicant: Clarence C. Mysen, San Francisco, CA (US)

(72) Inventor: Clarence C. Mysen, San Francisco, CA (US)

(73) Assignee: GOOGLE INC., Mountain View, CA (US)

(21) Appl. No.: 13/111,687

(22) Filed: May 19, 2011

(51) Int. Cl. G06Q 30/00

(52) U.S. Cl. CPC G01C 21/343

(57) ABSTRACT

Methods, systems, and computer program products are provided for detecting trigger events and providing information in response to trigger events. One example method includes identifying, from a network presence of an individual, historical data associated with the individual including determining data that is relevant to an activity, identifying, from the network presence of the individual, data associated with preferences of the individual including determining data that is relevant to the activity, generating a profile for the individual based at least in part on the historical data and the preference data, detecting a trigger event indicative of the individual being in a mode related to the activity, selecting information relevant to the activity, the profile, and the trigger event, and providing the selected information to the individual in response to detecting the trigger event.

### BACKGROUND

This specification generally relates to information presentation.

Users of the Internet and search engines can use such tools to perform research related to various activities and interests. Some businesses and organizations maintain websites that enable users to purchase various products and services. Businesses and organizations can use demographic information for targeting advertisements to Internet users.

### SUMMARY

In general, one innovative aspect of the subject matter described in this specification may be embodied in methods, systems, and computer program products for detecting trigger events and providing information in response to trigger events. One example method includes identifying, from a network presence of an individual, historical data associated with the individual including determining data that is relevant to an activity, identifying, from the network presence of the individual, data associated with preferences of the individual including determining data that is relevant to the activity, generating a profile for the individual based at least in part on the historical data and the preference data, detecting a trigger event indicative of the individual being in a mode related to the activity, selecting information relevant to the activity, the profile, and the trigger event, and providing the selected information to the individual in response to detecting the trigger event. The systems discussed here may provide one or more mechanisms for collecting information about users. Users may be provided with an opportunity to opt in/out of programs that may collect personalized information. In addition, certain data may be anonymized in one or more ways before it is stored or used, so that personally identifiable data is removed.

In general, another innovative aspect of the subject matter described in this specification may be embodied in methods that include the actions of identifying, from a network presence of a user, historical information associated with the user including filtering the historical information to determine information that is relevant to travel, identifying, from the network presence of the user, travel preferences of the user, based at least in part on the historical information, detecting an occurrence of a trigger event, the trigger event indicative of a start of a trip by the user, arrival at a location by the user, receiving from the user a search query associated with travel, or receiving from the user a map search, selecting information relevant to the travel history, the travel preferences, and the trigger event, and providing the selected information to the user at a time that is close in proximity to the detection of the trigger event.

In general, another innovative aspect of the subject matter described in this specification may be embodied in information providing systems that include activity relevance identifiers, profile generators, trigger event detectors, and activity-related information selectors. An activity relevance identifier can identify, from a network presence of a user, data associated with the user that is relevant to an activity. A profile generator can generate a profile for the user based at least in part on the identified data. A trigger event detector can detect a trigger event indicative of the user being in a mode related to the activity. An activity-related information selector can select information relevant to the activity, the profile, and the trigger event.

These and other embodiments may each optionally include none, one or more of the following features. In various examples, historical data or information associated with users or individuals can be identified from itineraries, geo-tagged photos, web page visits, message posts, reviews, search queries, and map searches. Selected information provided to users or individuals can be advertising content. Upon receiving requests by users or individuals, selected information can be re-provided.

Activities can be associated with travel and the historical data can include data associated with previous trips by individuals. Activities can be associated with shopping and the historical data can include data associated with previous purchases by individuals. Activities can be associated with dining and the historical data can include data associated with previous dining experiences of individuals.

Identifying historical data or preference data associated with individuals can include identifying data provided by individuals. Data provided by individuals can include search queries, posted messages, reviews, and photos. Identifying historical data or preference data can include identifying data associated with web pages accessed by individuals. Identifying preference data can include detecting patterns associated with the historical data. Generating profiles can include identifying locations, products, or services associated with the historical data or the preference data.

Information associated with multiple profiles including selectable profile features can be provided to content providers, and selected profile features can be received from the content providers. Information associated with the profiles can include counts of individuals associated with the selectable profile features. Auction bids for having information provided to individuals associated with selected profile features can be received from content providers, and information relevant to activities can be selected based at least in part on an auction process. Selecting information relevant to activities can be based at least in part on a prediction of interest of individuals in regard to the information.

Trigger events can include receiving from individuals search queries related to the activities. Trigger events can include receiving from individuals requests for map searches.

Reasons for providing information to individuals can be provided to individuals. Options for accessing previously provided information can be provided to individuals. The information can be related to advertising.

Particular embodiments of the subject matter described in this specification may be implemented to realize none, one or more of the following advantages. Historical and current user patterns of engagement and user preferences can be considered when providing information to users. Relevant information can be provided to users at appropriate times. Provided information can be personalized to users. Advertisers can bid on specific characteristics of an event, and can receive improved return on investment from improved data/content targeting.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a diagram of an example system that can provide information to system users in response to trigger events.

FIG. 2 is a diagram of an example system that can detect an occurrence of a trigger event and can provide information to system users.

FIGS. 3A and 3B show example user interfaces for providing information.

FIG. 4 is a diagram of an example system that can provide profile information to content providers.

FIGS. 5 and 6 are flowcharts of example processes for selecting and providing information to users.

FIG. 7 shows an example of a computer device and a mobile computer device that can be used to implement the techniques described here.

Like reference symbols in the various drawings indicate like elements.

### DETAILED DESCRIPTION

In general, computer systems can generate user profiles based on user actions and preferences in regard to various activities (e.g., travel, shopping, dining, etc.). Upon receiving a trigger event indicative of a particular user being in an activity mode (e.g., planning or engaging in the activity), the systems can select information relevant to the activity, the user's profile, and the trigger event. The information can be provided to a computing device operated by the user for presentation. The systems discussed here may provide one or more mechanisms for collecting information about users. Users may be provided with an opportunity to opt in/out of programs that may collect personalized information. In addition, certain data may be anonymized in one or more ways before it is stored or used, so that personally identifiable data is removed.

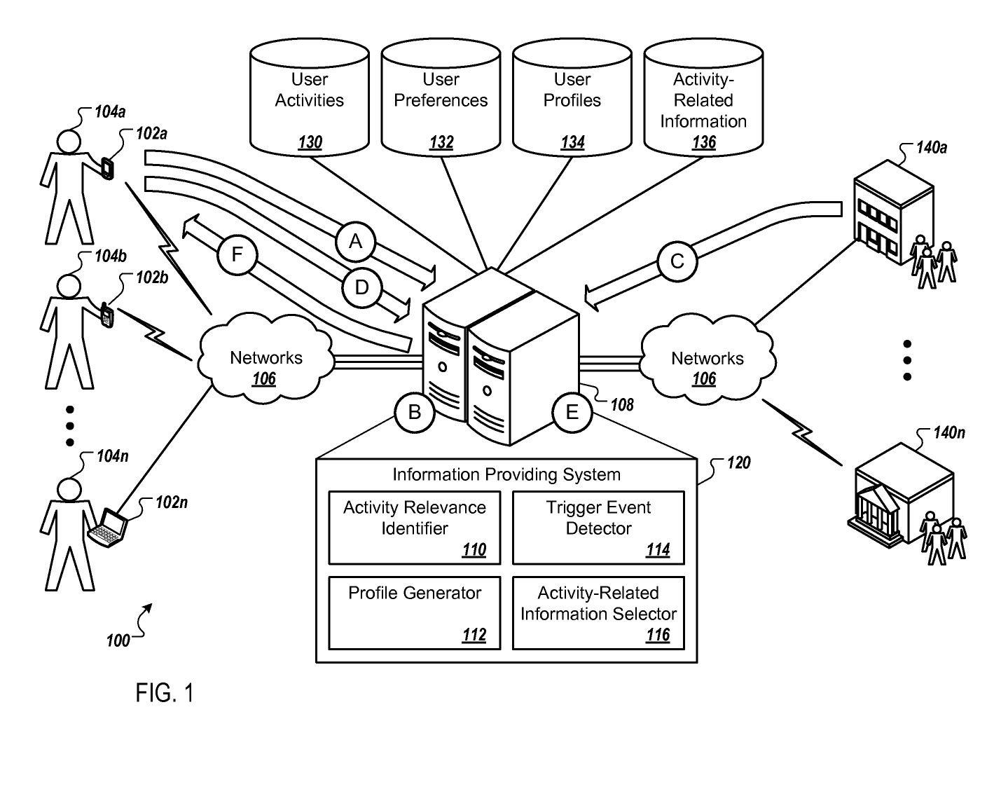

FIG. 1 is a diagram of an example system 100 that can provide information to system users in response to trigger events. FIG. 1 also illustrates an example flow of data within the system 100 during states (A) to (F), where the states (A) to (F) may occur in the illustrated sequence, or they may occur in a sequence that is different than in the illustrated sequence.

In further detail, the system 100 includes one or more client computing devices 102 (each operated by a corresponding user 104) that communicates over one or more networks 106 with one or more computing servers 108. The networks 106 may include a wireless cellular network, a wireless local area network (WLAN) or WiFi network, a Third Generation (3G) or Fourth Generation (4G) mobile telecommunications network, or any appropriate combination thereof.

The client device(s) 102 may be any appropriate type of computing device (e.g., mobile phone, smart phone, PDA, music player, e-book reader, tablet computer, laptop or desktop computer, or other stationary or portable device) that includes one or more processors and computer readable media. Among other components, for example, the client device(s) 102 includes one or more processors, computer readable media that store software applications, input device(s) (e.g., touch screens, keyboards, computer mice, motion sensors, microphones, and the like), output device(s) (e.g., display screens, speakers, and the like), and communications interfaces.

The computing server(s) 108 may be configured to execute application code associated with a variety of software components (e.g., modules, objects, libraries, services, and the like), including computer instructions to perform some or all of the method steps described below. In some implementations, the computing server(s) 108 may include one or more components of an information providing system 120 for providing information to users in response to trigger events. The information providing system 120 can include an activity relevance identifier 110, a profile generator 112, a trigger event detector 114, and an activity-related information selector 116. Two or more of the components 110, 112, 114, and 116 may be implemented on the same computing device, or on different computing devices, such as devices included in a server farm or a peer-to-peer network.

The information providing system 120 and the server(s) 108 may be in communication with one or more data storage devices, including a user activities data store 130, a user preferences data store 132, a user profiles data store 134, and an activity-related information data store 136. The data stores 130, 132, 134, and 136 can implement databases, file systems, and the like, to add, remove, and maintain data used by the system 100. For example, one or more of the data stores 130, 132, 134, and 136 can be used to maintain network presence data associated with each of the users 104. Network presence data, for example, may be indicative of subjective preferences of the users 104, and may include data related to web site traffic, conversations such as blog posts and replies, instant messaging sessions, reviews, comments, social networking posts, and/or email conversations associated with the users. In some implementations, network presence data may include user settings regarding use of the network presence data. For example, the users 104 can provide settings data via client devices 102, including privacy settings related to the network presence data, and permissions settings regarding how such data may be used.

Referring to the example flow of data, during state (A), information associated with user activities and preferences can be identified. For example, the user 104a can employ the client device 102a to provide to the computing server(s) 108 and the information providing system 120 information related to an activity (e.g., travel, shopping, dining, etc.), and activity preferences (e.g., preferred types, locations, budgets, etc.). In some implementations, such information may be directly provided by users. For example, the user 104a can employ one or more computer applications executed by the client device 102a and/or the computing server(s) 108 to specify information related his or her activities and activity preferences. In some implementations, such activity-related information may be inferred from user interaction with applications such as web browsers, search engines, and e-mail. For example, search queries provided by the user 104a to a search engine (not shown) can be provided to the information providing system 120 for inferring user activities and/or activity preferences. As another example, web browsing behavior information (e.g., website visits, map searches, link clicks) can be provided to the information providing system 120 and can be used to infer such user information.

In some implementations, activity and activity preference information may be identified from historical user data. For example, information directly provided by users 104 and information inferred from interactions of users 104 with various applications can be stored by the user activities data store 130 and/or the user preferences data store 132 for use in further processing. In some implementations, historical user data may be filtered to identify information relevant to a particular activity and/or activity preference. For example, as user data is received by the computing server(s) 108 and the information providing system 120, the activity relevance identifier 110 can filter the data to identify information relevant to the particular activity and/or activity preferences, and the filtered data can be stored and/or provided to additional software components for further processing. As another example, historical user data can be directly received and stored by the user activities data store 130 and/or the user preferences data store 132 and can be filtered during subsequent processing.

During state (B), user profiles can be generated. For example, the information providing system 120 can receive historical user activity data associated with the user 104a from the user activities data store 130 and user preference data associated with the user 104a from the user preferences data store 132, and can provide the data to the profile generator 112 to generate a user profile for the user 104a, based at least in part on such data. As another example, the information providing system 120 can receive activity and/or activity preference data associated with the user 104a in real-time (e.g., during web browsing sessions), and can generate and/or update a profile associated with the user 104a as data is received. User profiles, for example, can include information related to user preferences and tastes in regard to a particular activity, and can provide a basis for defining users. Upon generating and/or updating user profiles by the profile generator 112, for example, the profiles can be stored by the user profiles data store 134 for further processing and use.

During state (C), entities (e.g., organizations, businesses, advertisers) can target aspects of user profiles. For example, the entity 140a can provide information (e.g., text, video, audio, web links, recommendations, advertisements, etc.) related to a particular activity, and can specify profile features of users 104 that are to receive such information. Upon receiving the information, for example, the information can be stored by the activity-related information data store 136 for later providing to users 104. In some implementations, targeting can be auction-based. For example, multiple entities 140 can participate in an auction for providing information to users 104, and the information can be provided in accordance with one or more completed auctions.

During state (D), a trigger event can be recognized indicative of a user being in a mode related to a particular activity. For example, the user 104a can employ the client device 102a to enter a search query or map search, and the trigger event detector 114 can identify the search as being relevant to the activity. As another example, the user 104a can move between locations, and the trigger event detector 114 can identify the change in location as being relevant to the activity (e.g., the start of a trip, a shopping session, a dining experience, etc.).

During state (E), information relevant to an activity, user profile, and trigger event can be identified/selected. For example, upon determining that the user 104a is in a mode related to a particular activity, the information providing system 120 can provide user profile information associated with the user 104a to the activity-related information selector 116. Based at least in part on the user profile information, the activity-related information selector 116 can select from information associated with one or more entities 140. For example, the entity 140a may have indicated intent to provide information to users having particular profile features, at a time when the users are in an activity mode. In the present example, the activity-related information selector 116 can determine that the user 104a has one or more of the particular profile features, and can select information associated with the entity 140a for providing to the user.

During state (F), selected information can be provided users. For example, information related to an activity (e.g., travel, shopping, dining, etc.) mentally or physically engaged in by the user 104a can be provided to the user, based at least in part on the profile of the user 104a. Thus, historical and current user patterns of engagement and user preferences can be considered when providing information to users. In addition, relevant information can be provided to users at appropriate times.

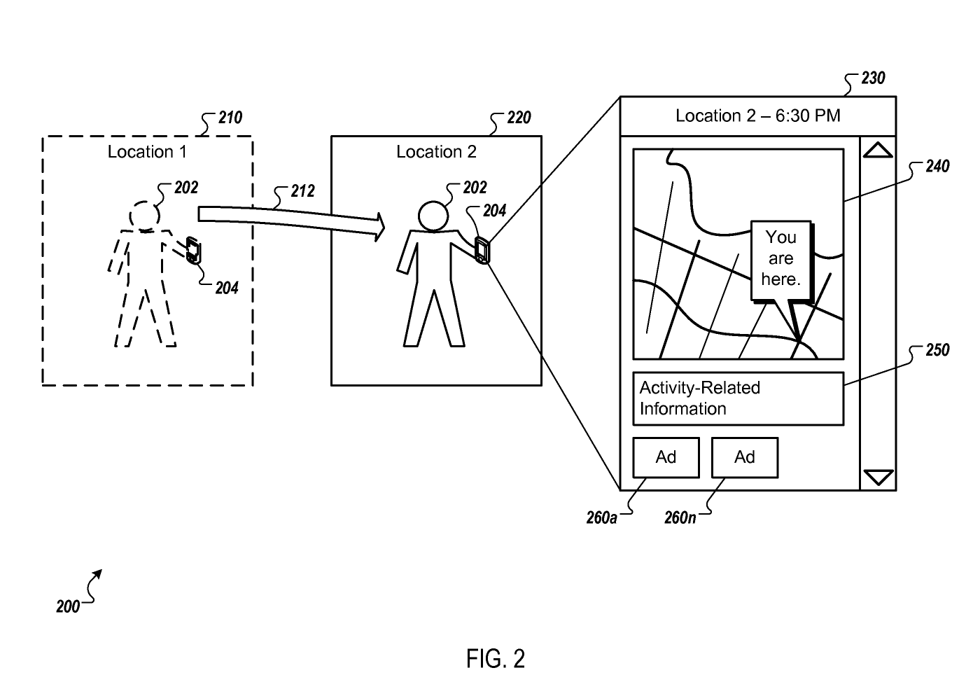

FIG. 2 is a diagram of an example system 200 that can detect an occurrence of a trigger event and can provide information to system users. In some implementations, a trigger event may be indicative of a start of a trip or an arrival at a location. Based at least in part on the trigger event, for example, information can be selected and provided to users. In some implementations, no user input is specifically required to signal a trigger event (i.e., the user can move to a location, but is not required to provide, for example, a search request once they arrive at the location to trigger the event).

In the present example, a user 202 employs a client device 204 at a first location 210. As shown by arrow 212, for example, the user 202 can move to a second location 220. For example, the user 202 may have started a vacation or business trip, or may have started a regular sort of travel such as commuting. Based on location information provided by the client device 204, a system for providing information to system users in response to trigger events (e.g., system 100, shown in FIG. 1) can select and provide information (e.g., content, recommendations, and advertisements) to the user 202. Location information can be provided by, for example, GPS (Global Positioning System) capabilities of the client device 204, by location reporting of the user 202, or by any other appropriate technique.

In some implementations, information can be provided to the client device 204 (e.g., by the system 100) and presented to the user 202 by an interface 230. For example, the interface 230 can include visual, audio, and motion (e.g., vibration) aspects. In the present example, the interface 230 includes a map interface 240, an activity-related information interface 250, and advertisement interface(s) 260. In some implementations, additional information may be provided via the interface 230. For example, addition information may be provided by associating web page links to any of the interfaces 240, 250, and 260, and by using a web browser application to follow the links.

To illustrate selecting and providing of information to users, the trigger event may be an arrival at an airport by the user 202. Based on a travel-related profile of the user 202, for example, the system 100 may determine that the user 202 generally books a hotel room shortly after arrival, and that the user generally prefers medium-priced hotels that have swimming pools. Thus, the system 100 may select and provide information associated with such hotels to the user 202 via the interface 230. As another example, upon arriving at the airport, the user 202 may enter a map search. Upon recognizing that the user 202 is in a travel-related mode based on receiving the map search, for example, the system 100 can provide map information via the map interface 240, including locations of hotels that may be preferred by the user 202. As another example, hotel information can be provided to the user 202 via the activity-related information interface 250 and/or via the advertisements interface(s) 260.

In some implementations, time factors may be considered when selecting and providing information to users. For example, the user 202 may arrive at the airport at 6:30 p.m. Based on a travel and/or dining-related profile of the user, for example, the system 100 may determine that the user 202 generally visits restaurants around 6:30 p.m. while traveling, and that the user 202 generally prefers airport establishments that serve beer. Thus, information and/or advertisements related to such establishments can be selected and provided to the client device 204 for presentation to the user 202 via the interface 230.

By detecting trigger events indicative of users being in an activity mode, for example, information can be selected and provided to users when the users are planning, engaged in, or otherwise occupied with the activity. Although location and time-based examples have been described, other sorts of trigger events are possible, such as triggers associated with user interaction with search engines and websites. In some implementations, particular query terms can be tagged as related to particular activities. For example, the terms “hotel” or “flight” may be tagged as being related to travel. As another example, a series of queries can be considered for determining when a user is in an activity mode.

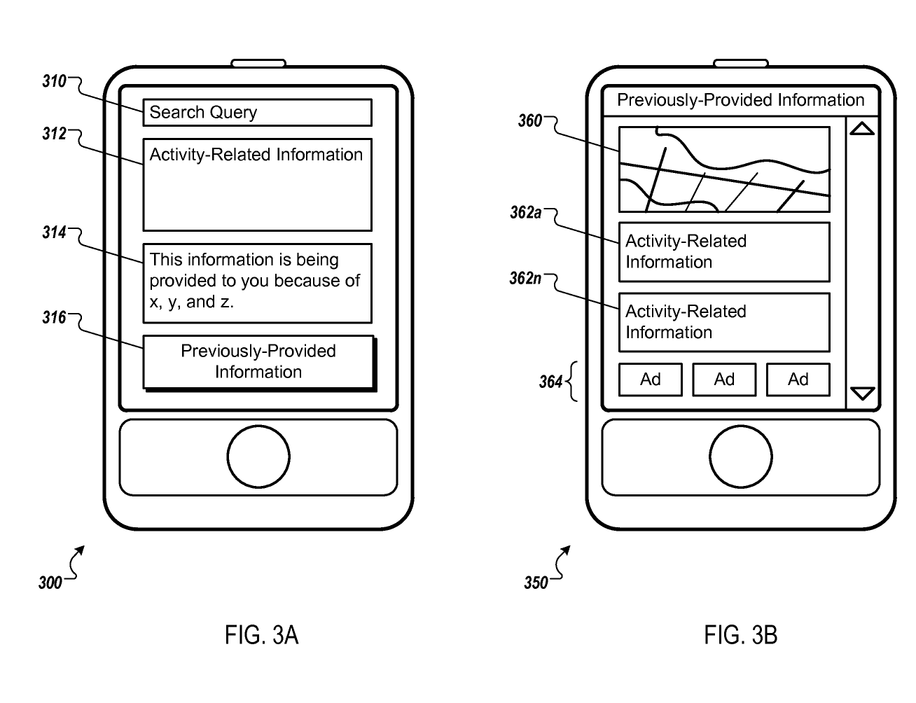

FIGS. 3A and 3B show example user interfaces 300, 350 for providing information. In some implementations, the information can include information selected as being relevant to an activity, a user profile, and a trigger event. For example, the interfaces 300, 350 can be presented by client devices 104 (shown in FIG. 1), and can include visual, audio, and motion (e.g., vibration) aspects.

In the present example, the interface 300 includes a search query interface 310, an activity-related information interface 312, a message interface 314, and a previously-provided information interface 316. For example, users can interact with the search query interface 310 to provide search queries to a search engine by typing, speaking, submitting photos, or any other appropriate technique. The search engine, for example, can provide information related to the search queries to a system for providing information to users in response to trigger events (e.g., system 100, shown in FIG. 1). If a trigger event indicative of a user being in a mode related to an activity is detected, for example, information relevant to the activity, a profile of the user, and the trigger event can be presented to the user via the interface 300. Activity-related information (e.g., content, recommendations, advertisements, etc.) can be presented via the activity-related information interface 312, for example.

In some implementations, a reason for providing information to the user can be provided. For example, information related to the reason can be presented to the user via the message interface 314. The reason, for example, can include information related to how the profile of the user was used in selecting activity-related information. For example, if the user had indicated a preference for hotels with swimming pools, preference information may be presented in association with hotel information. As another example, if the user is associated with a history of searching for or booking rooms in medium-priced hotels, the history information may be presented in association with hotel information. By providing the reason for selecting and providing information, for example, a degree of transparency can be provided in regard to how user activity profile information is used.

In some implementations, an option for accessing previously provided information can be provided. For example, the option can be provided via the previously-provided information interface 316 (e.g., a series of thumbnails, a command button or link for navigating to another screen, etc.). By interacting with the previously-provided information interface 316, for example, users can access information previously provided in recognition of a trigger event. In the present example, previously provided information can be presented to users through the interface 350, which includes a previously-presented map interface 360, previously-presented activity-related information interface(s) 362, and previously-presented advertisement interface(s) 364. In some implementations, users may be provided with variable or rotating information. By accessing the option for accessing previously provided information, for example, users can revisit such information if desired.

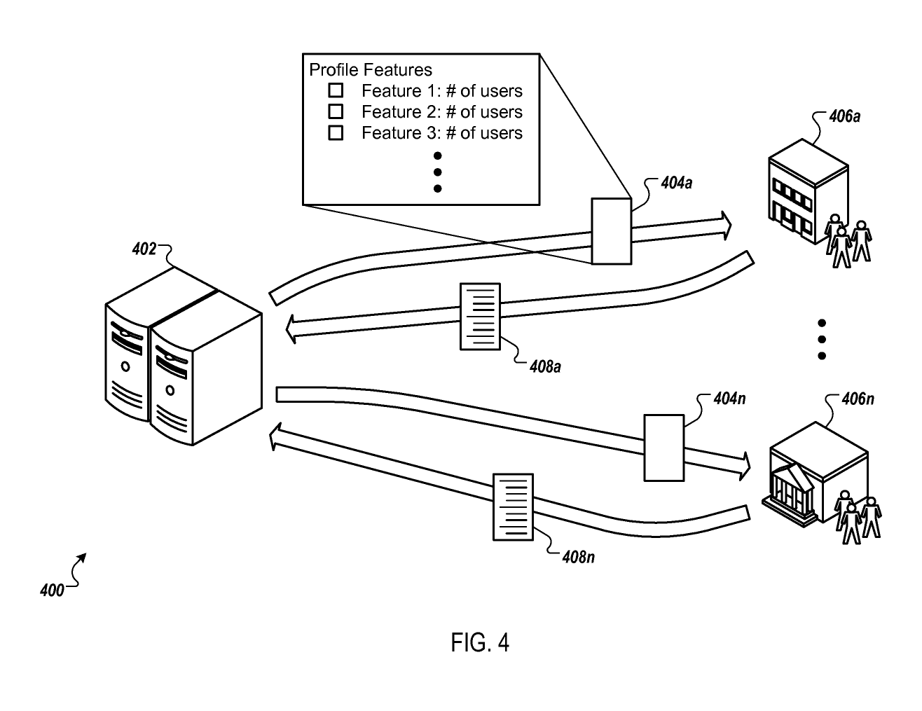

FIG. 4 is a diagram of an example system 400 that can provide profile information to content providers. In some implementations, multiple entities (e.g., organizations, businesses, advertisers) can be provided with information associated with multiple user profiles including selectable profile features. By selecting profile features available for targeting, for example, the entities can publish information (e.g., content, recommendations, advertisements) to users matching their criteria. In some implementations, multiple entities can bid against the features, and selecting and providing information to users may be based at least in part on an auction process.

In the present example, computing server(s) 402 can provide feature information 404 to entities 406. In some implementations, the feature information 404 can include counts of individuals associated with the selectable profile features. For example, the computing server(s) 402 can identify a profile feature such as “swimmer” and can determine that a certain number of users have indicated a preference for swimming-related activities, or have demonstrated a history of booking reservations for facilities with swimming pools, or have performed web searches for such facilities. The entities 406, for example, can select from and/or bid against the provided features, and can provide selection and/or bid information 408 to the computing server(s) 402. In some implementations, the computing server(s) may be included as part of or may be in communication with the computing server(s) 108 and the information providing system 120 (shown in FIG. 1).

Feature selection and/or bid information 408 received from each of the entities 406 can be used by the computing server(s) 402 for selecting information relevant to activities, user profiles, and trigger events. For example, upon determining that a particular user associated with a “swimmer” profile feature is in a travel mode (e.g., researching hotels), the computing server(s) 402 may provide the user with information associated with one or more entities 406 (e.g., hotels) that have selected the feature. In implementations including auctions, for example, information associated with one or more auction-winning entities 406 may be provided to the user. Thus, in the present example, hotels with swimming pools may provide content (e.g., advertisements) to individuals who are likely to have an interest in such amenities.

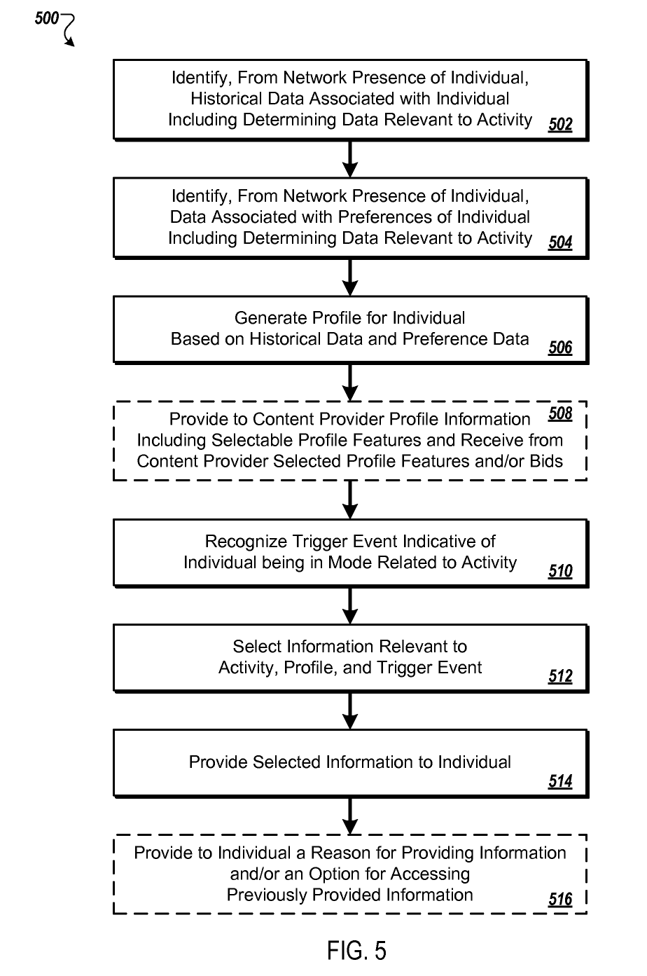

FIG. 5 is a flowchart of an example process 500 for selecting and providing information to users. In some implementations, the process 500 may be performed by the systems 100, 200, 300, and/or 400, and will be described as such for the purpose of clarity. Briefly, the process 500 includes identifying historical data associated with individuals, identifying data associated with preferences of individuals, generating profiles for individuals based on historical data and preference data, optionally providing to content providers profile information including selectable profile features and receiving selected profile features and/or bids, detecting trigger events indicative of individuals being in an activity-related mode, selecting information relevant to activities, profiles, and trigger events, providing selected information to individuals, and optionally providing to individuals a reason for providing information and/or an option for accessing previously provided information.

In more detail, historical data associated with individuals can be identified (502) from network presences of individuals, including determining data that is relevant to an activity. For example, the computing server(s) 108 and the information providing system 120 can receive data associated with user(s) 104, and can use the activity relevance identifier 110 to identify data related to activities. By interacting with one or more client device applications, for example, the user(s) 104 can provide explicit and implicit activity-related data.

In some implementations, activity types may be defined by administrators of the system 100, including defining the types of data associated with the activity. For example, the activity may be associated with travel and the historical data may include data associated with one or more previous trips by an individual. As another example, the activity may be associated with shopping and the historical data may include data associated with one or more previous purchases by the individual. As another example, the activity may be associated with dining and the historical data may include data associated with one or more previous dining experiences of the individual.

Data associated with preferences of individuals can be identified (504) from network presences of individuals, including determining data that is relevant to the activity. For example, the computing server(s) 108 and the information providing system 120 can receive preference data associated with user(s) 104, and can use the activity relevance identifier 110 to identify preference data related to activities. Preference data, for example, can include preferred types, locations, budgets, etc., in regard to various activities. For example, in regard to travel activities, a particular individual may have a preference for beach or warm weather vacations. As another example, in regard to shopping activities, a particular individual may have a preference for upscale shops featuring suits. As another example, in regard to dining activities, a particular individual may have a preference for non-chain burger joints serving beer.

In some implementations, the identified history and preference data may be provided by individuals. For example, the user 104a can use the client device 102a to create and manage trip itineraries, and the itinerary data can be provided to the profile generator 112 for generating a travel-related profile for the user 104a. As another example, the user 104a can employ one or more computer applications executed by the client device 102a and/or the computing server(s) 108 to explicitly indicate his or her activities and activity preferences.

In some implementations, data provided by individuals may include search queries. For example, the user 104a can use the client device 102a to access a search engine and to search for information and websites related to a particular activity. The search engine can provide data associated with the search session to the information providing system 120, for example, where relevance to the activity may be determined by the activity relevance identifier 110. In some implementations, relevance may be determined by tagging particular query terms and associating the terms with activity categories. In some implementations, a classifier may be created for queries and groups of queries for determining relevance to particular activities.

In some implementations, data provided by individuals may include posted messages, reviews, and/or photos. For example, the user 104a can use the client device 102a to access websites for posting such data, and the activity relevance identifier 110 can identify and process the data and can determine whether the data is relevant to a particular activity. If the user 104a posts a message or a review about a particular restaurant or style of cuisine, for example, the activity relevance identifier 110 can parse the message or review, can determine whether the message or review is related to dining activity, and can associate the message or review sentiment with the user 104a. As another example, if the user 104a posts a geo-tagged photo of a particular location, the activity relevance identifier 110 can identify the photo location, can determine whether the photo is related to travel activity, and can identify the location as a location of interest to the user 104a.

In some implementations, data provided by individuals may include data associated with web pages accessed by individuals. For example, the user 104a can use the client device 102a to visit websites during a web browsing session. Upon receiving information associated with the visited websites, for example, the activity relevance identifier 110 can crawl the websites and can extract data from the websites relevant to various activities. For example, if the user 104a visits a website related to purchasing a particular product or service, the activity relevance identifier 110 can determine whether the website is related to shopping activity, and can associate the product or service with the user 104a.

In some implementations, identifying preference data may include detecting one or more patterns associated with the historical data. For example, if the information providing system 120 determines that the user 104a has a search history including search queries related to American sports cars, and/or has visited web sites related to American sports cars, and/or has posted messages, reviews or photos related to American sports cars, it may be determined that the user 104a has a preference for American sports cars. As another example, an individual's travel preferences (e.g., types of transportation, lodging, etc.) over a period of months or years can be compiled to identify seasonal travel preferences of the individual. For example, it may be determined that the user 104a tends to be interested in or to engage in warm weather vacations during January.

Profiles for individuals can be generated (506) based at least in part on the historical data and the preference data. For example, the information providing system 120 can use the profile generator 112 to generate a profile for the user 104a based on historical data and preference data associated with the user. The generated profile can be used by subsequent processes as an indicator of an individual's tastes and preferences in regard to a particular activity.

In some implementations, generating profiles can include identifying one or more locations, products, or services associated with the historical data or the preference data. For example, the profile generator 112 can cluster location, product, or service information included in the historical or preference data to extract profile information. As another example, frequent patterns in the data (e.g., common airlines used, common flight times, rankings of selected hotels, price ranges for hotels and flights, etc.) can be identified for generating the profile.

Optionally, information associated with multiple profiles, including selectable profile features, can be provided (508) to content providers, and selected profile features can be received from content providers. Referring to FIG. 4, for example, the computing server(s) 402 can provide feature information 404 including selectable profile features to various entities 406. In some implementations, selectable profile features may pertain to various activity-related profiles associated with system users. For example, travel-related profiles of multiple users may include information indicating whether the users have visited Hawaii in the past. Thus, in the present example, the selectable profile features can include an option enabling the entities 406 to select users having visited Hawaii. For example, an interface including selection boxes associated with the selectable profile features can be presented to the entities 406. As another example, the interface can include search capabilities enabling the entities 406 to identify profile features of interest.

In some implementations, the information associated with multiple profiles may include a count of individuals associated with the selectable profile features. For example, the computing server(s) 402 can count users associated with particular profile features, and can provide count information in association with descriptions of the features. Thus, in the present example, a count of users having visited Hawaii can be presented to the entities 406.

In some implementations, content providers may provide auction bids for having information provided to individuals associated with particular profile features. For example, entities 406 may select one or more profile features included in the feature information 404, and may indicate the prices (e.g., based on cost per click, cost per view, or some other appropriate pricing model) they are willing to pay for having information provided to users associated with one or more of the selected profile features. In the present example, the entity 406a may be an airline or a travel agency. The entity 406a can select a profile feature associated with users having visited Hawaii, for example, and may bid against other entities 406 for the opportunity to provide information (e.g., advertisements) to such users.

Selected profile features and/or auction bids can be received from content providers. For example, the computing server(s) 402 can receive feature selection and/or bid information 408 from the entities 406. In some implementations, the entities 406 may also provide information associated with content (e.g., advertisements) to be provided to users. For example, the entity 406a may provide an advertisement (e.g., “Save 20% on a flight to Hawaii.”) including parameters or embedded promotion codes enabling the entity 406a to identify users that interact with the advertisement. Thus, the entity 406a in the present example can manage a targeted advertising campaign based on providing information to users associated with desired profile features.

A trigger event indicative of an individual being in a mode related to an activity can be detected (510). Referring to FIG. 1, for example, the information providing system 120 can use the trigger event detector 114 to detect the trigger event. In general, trigger events may include events associated with user planning of or engagement in particular activities. Considering travel activity, for example, trigger events may include such events as starting a trip, arriving at a particular destination, performing a travel-related search, and performing a map search. Considering shopping activity, for example, trigger events may include such events as arrival at a shopping center, browsing shopping websites, and performing searches for particular products or services. Considering dining activity, for example, trigger events may include such events as occurrences of meal times, arrival at a restaurant district, and performing dining-related searches. In the present example, the user 104a can employ the client device 102a to perform travel-related searches for beach vacations, and the trigger event detector 114 can recognize the search session as a trigger event associated with travel activity.

Information relevant to the activity, the individual profile, and the trigger event can be identified or selected (512). For example, the information providing system 120 can use the activity-related information selector 116 to select information associated with entities 140 for providing to users 104 associated with particular profile features. In the present example, the activity-related information selector 116 can access a travel-related profile associated with the user 104a to determine that the user has visited Hawaii in the past. The activity-related information selector 116 can identify one or more entities 140 that have indicated intent for providing information to users having visited Hawaii, and can select information associated with information associated with such entities.

In some implementations, the type of trigger event may be used as a factor in selecting information for providing to users. For example, upon detecting a search query related trigger event, the information selector 116 can determine that the user 104a is engaging in travel-related research. Thus, in the present example, information that may be relevant to the user 104a while performing research for a trip to Hawaii, such as flight and hotel information, may be selected. As another example, upon detecting a trigger event indicative of a start of a trip or arrival at a location, the information selector 116 can determine that the user 104a is currently traveling. Thus, information that may be relevant to the user 104a while vacationing in Hawaii, such as local travel activity options (e.g., helicopter rides, snorkeling, luaus, etc.), for example, may be selected.

In some implementations, selecting information relevant to the activity may be based at least in part on an auction process. The auction process may include various techniques for evaluating bids and determining auction winners. In some implementations, the auction process can include a comparison of bids, augmented in part by quality scores (e.g., based on click rates, user feedback, or some other appropriate technique) associated with content providers. For example, the entity 140a may be identified as having placed a competitive auction bid, and as being associated with a competitive quality score. In the present example, the information providing system 120 can run an auction participated in by multiple entities 140, and can select the entity 140a as an auction winner. In accordance with the auction process, for example, information associated with the entity 140a can be selected for providing to the user 104a.

In some implementations, selecting information relevant to the activity may be based at least in part on a prediction of interest of the individual in regard to the information. For example, based on interaction (e.g., views, clicks, etc.) of users 104 with previously provided information, the activity-related information selector 116 can select information likely to be of interest. To predict user interest, for example, one or more prediction models using activity profile and trigger event information can be referenced by the activity-related information selector 116.

Selected information can be provided (514) to the individual in response to detecting the trigger event. For example, the information providing system 120 can provide information associated with the entity 140a to the client device 102a for presentation to the user 104a. In some implementations, the information may be related to advertising. For example, the information associated with the entity 140a can be an advertisement for flights to Hawaii, including text, audio, image, and/or video elements.

Optionally, a reason for providing the information and/or an option for accessing previously provided information can be provided (516) to the individual. Referring to FIG. 3A, for example, the interface 300 can include a message interface 314 for providing information related to how the profile of the individual was used in selecting activity-related information. Referring to FIG. 3B, for example, the interface 350 can include interfaces 360, 362, and 364 for presenting previously presented information on request of the individual.

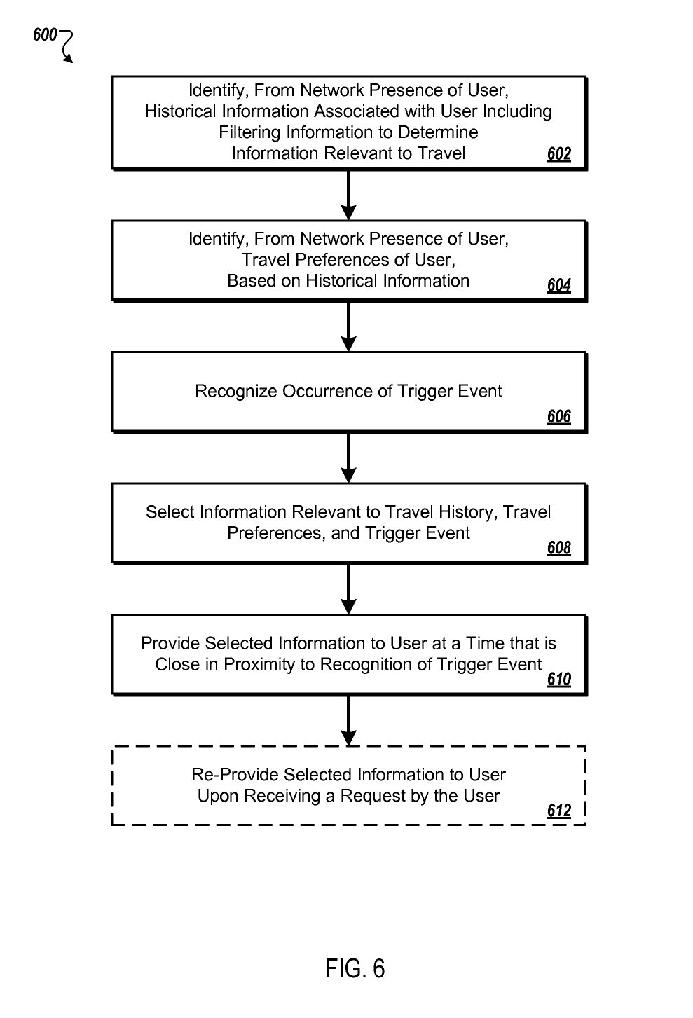

FIG. 6 is a flowchart of an example process 600 for selecting and providing information to users. In some implementations, the process 600 may be performed by the systems 100, 200, 300, and/or 400, and will be described as such for the purpose of clarity. Briefly, the process 600 includes identifying historical information associated with users including filtering information to determine information relevant to travel, identifying user travel preferences based on historical information, detecting occurrences of trigger events, selecting information relevant to travel history, travel preferences, and trigger events, providing selected information to users at a time that is close in proximity to the detection of a trigger event, and optionally re-providing selected information to users upon receiving user requests.

In more detail, historical information associated with a user can be identified (602) from a network presence of the user. Referring to FIG. 1, for example, the activity relevance identifier 110 can receive historical information associated with the user 104a from the user activities data store 130, filtering the historical information to determine information that is relevant to travel. For example, the historical information can include information associated with itineraries, geo-tagged photos, web page visits, message posts, reviews, search queries, and map searches.

Travel preferences of the user can be identified (604) from the network presence of the user. For example, based at least in part on the filtered historical information associated with the user 104a, the activity relevance identifier 110 and/or the profile generator 112 can identify travel preferences of the user 104a. The travel preferences can include preferences such as preferred destination types, travel times, airlines and hotels, and budgets, to describe a few possibilities.

An occurrence of a trigger event can be detected (606). For example, the trigger event detector 114 can receive information from the client device 102a operated by the user 104a indicative of trigger events such as a start of a trip by the user, arrival at a location by the user, entering of a search query associated with travel by the user, and entering of a map search by the user, to describe a few possibilities.

Information relevant to the user's travel history, travel preferences, and the trigger event can be selected (608). For example, the activity-related information selector 116 can select such information. In some implementations, the selected information may be advertising content. For example, the advertising content can be associated with one or more entities 140.

The selected information can be provided (610) to the user at a time that is close in proximity to the detection of the trigger event. For example, upon detecting a trigger event indicative of the start of a trip by the user 104a, travel-related advertising content can be selected and provided to the user 104a by the information providing system 120 at a time that is close (e.g., within 10 seconds, within a minute, within 10 minutes, etc.) to the start of the trip.

Optionally, the selected information can be re-provided (612) to the user. For example, after providing the selected information to the user 104a at a time that is close in proximity to the detection of the trigger event, the information can be re-provided upon receiving a request by the user 104a. For example, the user 104a can use the client device 102a to request and receive previously presented information.

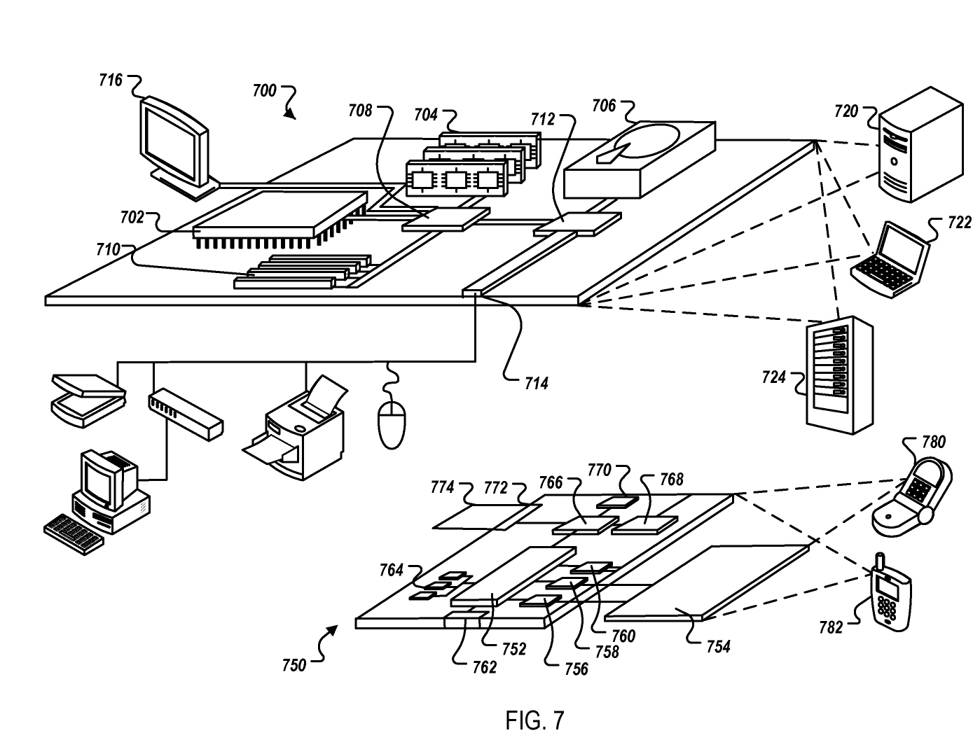

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method comprising:
identifying, from a network presence of a user, historical user interaction information;
identifying, from the network presence of the user, travel preferences of the user for a particular activity;
generating a profile for the user that includes inferred interests that were inferred using the historical user interaction information and the travel preferences;
determining, by one or more processors based on geolocation information obtained from a global positioning module of a user device of the user, that the user is traveling on a trip according to a stored trip itinerary;
detecting, by one or more processors and using a current location of the user obtained from the geolocation information, an occurrence of a trigger event, the trigger event indicating that the user has reached a given point in the trip itinerary; and
in response to detecting the trigger event:
selecting content using information about the given point in the trip itinerary and the generated profile, including at least a portion of the travel preferences and the inferred interests;
identifying a portion of the profile that was used to select the content;
accessing, in a data store, historical data specifying information that was previously presented to the user when the trigger event was previously detected during a previous trip; and
generating and outputting machine readable instructions that integrate, into a same user interface, a visual presentation of the selected content, a visual presentation of information identifying the portion of the profile that was used to select the content, and a previously-provided information interface that presents information that was previously presented to the user when the trigger event was previously detected during a previous trip using the accessed data, the selected content, and the identified portion of the profile.

2. The method of claim 1 wherein the historical user interaction information is identified from one or more of an itinerary, a geo-tagged photo, a web page visit, a message post, a review, a search query, or a map search.

3. The method of claim 1 wherein the selected content is advertising content.

4. The method of claim 1 further comprising re-providing the selected content to the user after providing the selected content to the user at a time that is close in proximity to the detection of the trigger event, upon receiving a request by the user.

5. A method comprising:
identifying, from a network presence of a user, historical user interaction data;
identifying, from the network presence of the user, preferences of the user for a particular activity;
generating a profile for the user that includes inferred interests that were inferred using the historical user interaction data and the preferences;
determining, by one or more processors based on geolocation information obtained from a global positioning module of a user device of the user, that the user is traveling on a trip according to a stored trip itinerary;
detecting, by one or more processors and using a current location of the user obtained from the geolocation information, an occurrence of a trigger event indicating that the user has reached a given point in the trip itinerary; and
in response to detecting the trigger event:
selecting content using information about the given point in the trip itinerary and the generated profile, including at least a portion of the preferences and the inferred interests;
identifying a portion of the profile that was used to select the content;
accessing, in a data store, historical data specifying information that was previously presented to the user when the trigger event was previously detected during a previous trip; and
generating and outputting machine readable instructions that integrate, into a same user interface, a visual presentation of the selected content, a visual presentation of information identifying the portion of the profile that was used to select the content, and a previously-provided information interface that presents information that was previously presented to the user when the trigger event was previously detected during a previous trip using the accessed data, the selected content, and the identified portion of the profile.

6. The method of claim 5 wherein the activity is associated with travel and wherein the historical user interaction data includes data associated with one or more previous trips.

7. The method of claim 5 wherein the activity is associated with shopping and wherein the historical user interaction data includes data associated with one or more previous purchases by the user.

8. The method of claim 5 wherein the activity is associated with dining and wherein the historical user interaction data includes data associated with one or more previous dining experiences of the user.

9. The method of claim 5 wherein identifying historical user interaction data or preference data includes identifying data provided by the individual user.

10. The method of claim 9 wherein data provided by the user includes one or more of a search query, a posted message, a review, or a photo.

11. The method of claim 5 wherein identifying historical user interaction data or preference data includes identifying data associated with a web page accessed by the user.

12. The method of claim 5 wherein identifying preference data includes detecting one or more patterns associated with the historical user interaction data.

13. The method of claim 5 wherein generating the profile includes identifying one or more locations, products, or services associated with the historical user interaction data or the preference data.

14. The method of claim 5 further comprising:
providing, to a content provider, information associated with multiple profiles including selectable profile features; and
receiving, from the content provider, selected profile features.

15. The method of claim 14 wherein the information associated with multiple profiles includes a count of users associated with the selectable profile features.

16. The method of claim 14 further comprising receiving from the content provider an auction bid for having content provided to users associated with the selected profile features, wherein selecting content relevant to the activity is based at least in part on an auction process.

17. The method of claim 5 wherein selecting content relevant to the activity is based at least in part on a prediction of interest of the user in regard to the content.

18. The method of claim 5 wherein detecting the occurrence of the trigger event includes receiving, from the user, a search query related to the activity.

19. The method of claim 5 wherein detecting the occurrence of the trigger event includes receiving, from the user, a request for a map search.

20. The method of claim 5 further comprising providing, to the user, a reason for selecting the content.

21. The method of claim 5 further comprising providing, to the user, an option for accessing previously provided content.

22. The method of claim 5 wherein the selected content is related to advertising.

23. A system comprising:
an information providing system that provides information to users in response to occurrences of trigger events, the information providing system including an activity relevance identifier, a profile generator, a trigger event detector, and an activity-related information selector;
wherein the activity relevance identifier identifies, from a network presence of a user, historical user interaction data;
wherein the profile generator:
identifies, from the network presence of the-user, preferences of the user for a particular activity; and
generates a profile for the user that includes inferred interests based at least in part on the identified data including inferring at least a portion of the data in the profile that were inferred using historical user interaction data and the preferences;
wherein the trigger event detector:
determines, by one or more processors based on geolocation information obtained from a global positioning module of a user device of the user, that the user is traveling on a trip according to a stored trip itinerary; and
detects, using a current location of the user obtained from the geolocation information, an occurrence of a trigger event indicating that the user has reached a given point in the trip itinerary;
wherein the activity-related information selector:
selects content using information about the given point in the trip itinerary and the generated profile, including at least a portion of the preferences and the inferred interests; and
determines identifying a portion of the profile that was used to select the content;
accesses, in a data store, historical data specifying information that was previously presented to the user when the trigger event was previously detected during a previous trip; and
wherein the information providing system generates and outputs machine readable instructions that integrate, into a same user interface, a visual presentation of the selected information and a visual presentation of information identifying the portion of the profile that was used to select the content, and a previously-provided information interface that presents information that was previously presented to the user when the trigger event was previously detected during a previous trip using the accessed data, the selected content, and the identified portion of the profile.
